(19) United States
(12) Patent Application Publication
(10) Pub. No.: US 2007/0096897 A1
(43) Pub. Date: May 3, 2007

(54) Attachment/location monitoring of a signal generating entity

(75) Inventor: Herbert S. Weiner, Portland, OR (US)

Correspondence Address: MARJAMA & BILINSKI LLP, 250 SOUTH CLINTON STREET, SUITE 300, SYRACUSE, NY, 13202, US

(73) Assignee: Welch Allyn, Inc., Skaneateles Falls, NY (US)

(21) Appl. No.: 11/263,050

(22) Filed: Oct. 31, 2005

(51) Int. Cl. G08B 1/08; G08B 23/00

(52) U.S. Cl. 340/539.13; 340/573.4; 340/539.21

(57) ABSTRACT

A method, apparatus and system for monitoring status information associated with a mobile entity, such as a person, another type of living thing or a device that generates a characteristic entity signal. The presence of a physical attachment between an attachment location reporting device and a mobile entity is verified via detection of the entity signal by the attachment monitoring device. Optionally, the attachment monitoring device can transmit a signal that reports the status of the attachment and can also function as, or be attached to, or be located within a range of proximity to, a location reporting device. Hence, the attachment monitoring device can report upon the status of the proximity of a location reporting device with respect to the location of the mobile entity.

### CROSS-REFERENCE TO APPLICATIONS INCLUDING RELATED SUBJECT MATTER

This application includes subject matter related to co-pending and commonly owned U.S. non-provisional patent application Ser. No. 11/031,736 (Attorney docket: 704_{—}047CON), filed Jan. 7, 2005), which is a continuation of non-provisional application Ser. No. 10/806,770 (Attorney docket: 704_{—}047), filed Mar. 22, 2004 claiming priority to U.S. provisional patent application Ser. No. 60/456,609 (Attorney docket: 704_{—}047PRO1), filed Mar. 21, 2003 and claims priority to U.S. provisional patent application Ser. No. 60/554,706 (Attorney docket: 704_{—}047PRO), filed Mar. 20, 2004. This application also includes subject matter related to commonly owned and issued U.S. Pat. No. 6,616,606 titled “Patient Monitoring System”. The aforementioned patent and all of the aforementioned patent applications are herein incorporated by reference in their entirety.

### FIELD OF THE INVENTION

This invention relates generally to reliably monitoring the status of an attachment between an attachment reporting device and a mobile entity, such as a person, another type of living thing or a device, in circumstances where the mobile entity generates a characteristic entity signal, such as an ECG or an EEG signal. In particular, the invention relates to reliably monitoring the status of an attachment between a mobile entity that generates a medical (physiologic) signal and a location reporting device, in order to reliably track the location of the mobile entity over a period of time.

### BACKGROUND OF THE INVENTION

Various status reporting devices, such as physiological status or location status reporting devices, are configured to report (communicate) status information associated with a person or an object to a remote location. Typically, a status reporting device is attached to a person or an object, Such as a piece of portable equipment. Often, the reliability of status information communicated from the status reporting device substantially depends upon the person or object to which the device is attached. For example, status reporting devices are substantially more reliable when attached to individuals other than those individuals who cannot be trusted to cooperate with the reporting of their status.

### SUMMARY OF THE INVENTION

The invention provides a method and apparatus for reliably monitoring the status of a physical attachment between an attachment monitoring device and a mobile entity, such as a person, another type of living thing, such as an animal or a device, in circumstances where the mobile entity generates a characteristic entity signal. The characteristic entity signal can be for example, an electrocardiogram (ECG) signal or an encephalogram (EEG) signal generated from a target, such as a person or other living thing. The presence of a physical attachment between an attachment monitoring device and a mobile entity is verified via continuous detection of the entity signal by the attachment monitoring device.

Optionally, the attachment monitoring device can transmit a signal that reports the status of the physical attachment and can also function as, or be attached to, or be located within a range of proximity to, another type of monitoring/reporting device, such as for example, a location reporting device.

In one type of embodiment, an attachment monitoring device is attached to a mobile entity and simultaneously attached to a location reporting device. The attachment monitoring device reports upon the status of an attachment between itself and the mobile entity while the location reporting device reports upon the location of the mobile entity, to a remote entity over a period of time. Severance of the attachment between the attachment monitoring device and the mobile entity or of the attachment between the location reporting device and the attachment monitoring device is reported to the remote entity.

The combination of both an attachment monitoring device and a location reporting device together forms a location monitoring apparatus that communicates more reliable location status information to the remote entity. Further, different types of physiological status monitoring devices can be used to implement an attachment monitoring device while different types of location monitoring devices, or non-location monitoring devices can be selectively intermixed into attached device combinations that can be reliably attached to and report upon the status of a mobile entity (target).

According to some variations, the attachment monitoring device and the location reporting device are combined (embedded) into a single device. Optionally, the reporting signals for the two devices can be combined into a single signal.

The foregoing as well as other objects, aspects, features, and advantages of the invention will become more apparent from the following description and from the claims.

### BRIEF DESCRIPTION OF THE DRAWINGS

The objects and features of the invention can be better understood with reference to the claims and drawings described below. The drawings are not necessarily to scale, the emphasis is instead generally being placed upon illustrating the principles of the invention. Within the drawings, like reference numbers are used to indicate like parts throughout the various views. Differences between like parts may cause those parts to be indicated by different reference numbers. Unlike parts are indicated by different reference numbers.

FIG. 1A illustrates an attachment monitoring device implemented as an ECG signal monitoring device that is configured to be attached to a person;

FIG. 1B illustrates an attachment monitoring device of FIG. 1A that is attached to a person;

FIG. 1C illustrates an attachment monitoring system that includes a plurality of attachment monitoring devices of FIG. 1A;

FIG. 2A illustrates a location monitoring device that is attached to a cart;

FIG. 2B illustrates a location monitoring system that includes at least one location monitoring device of FIG. 2A;

FIGS. 3A-3B illustrate an embodiment of an enhanced location monitoring apparatus that is formed from attaching a location monitoring device to an attachment monitoring device;

FIG. 3C illustrates a combined monitoring system 350 including at least one combined attachment and location monitoring device 312a-312n of FIG. 3B; and

FIG. 4 is a table illustrating a qualitative estimate of the relative reliability of attachment status information provided by the enhanced location monitoring apparatus of FIGS. 3A and 3B.

### DETAILED DESCRIPTION OF THE INVENTION

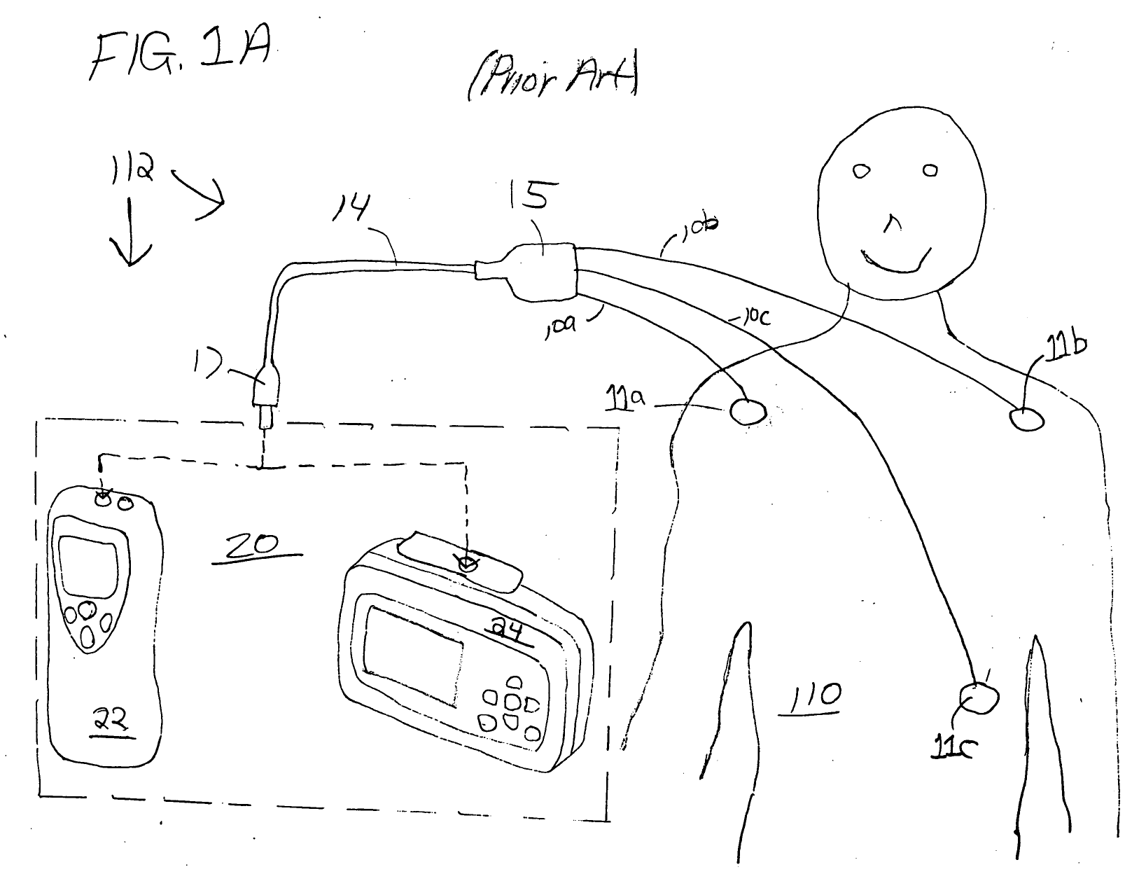

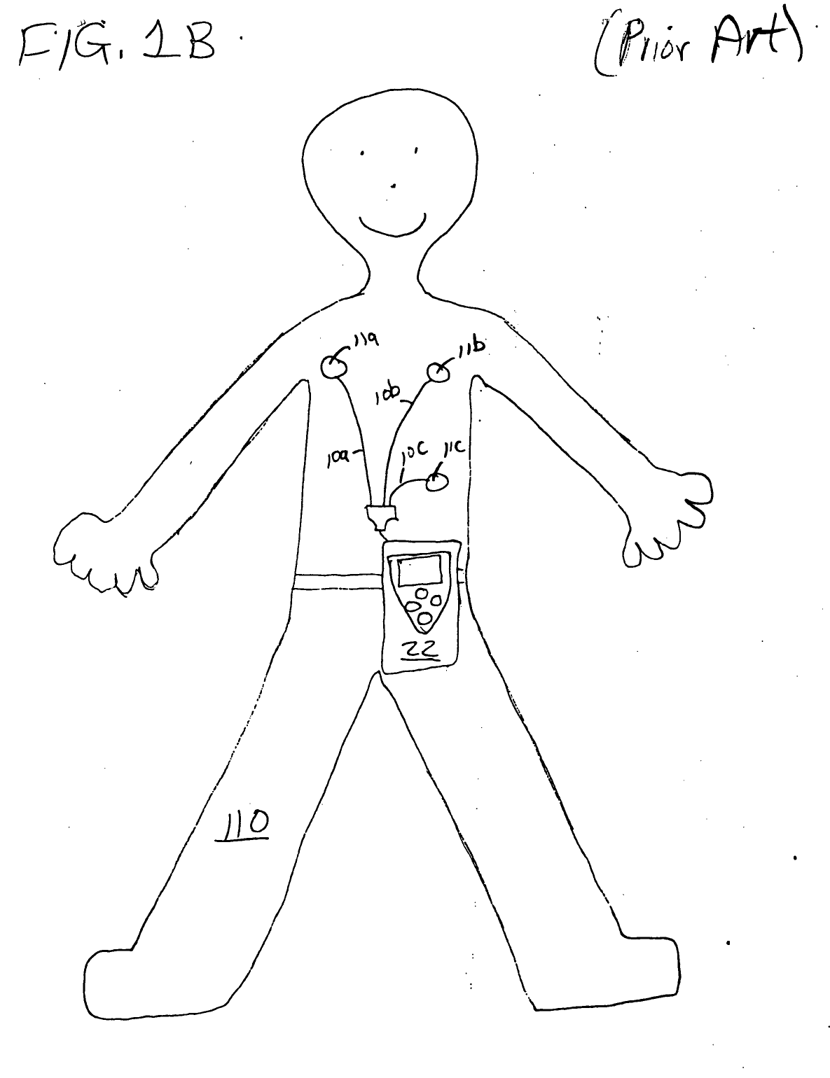

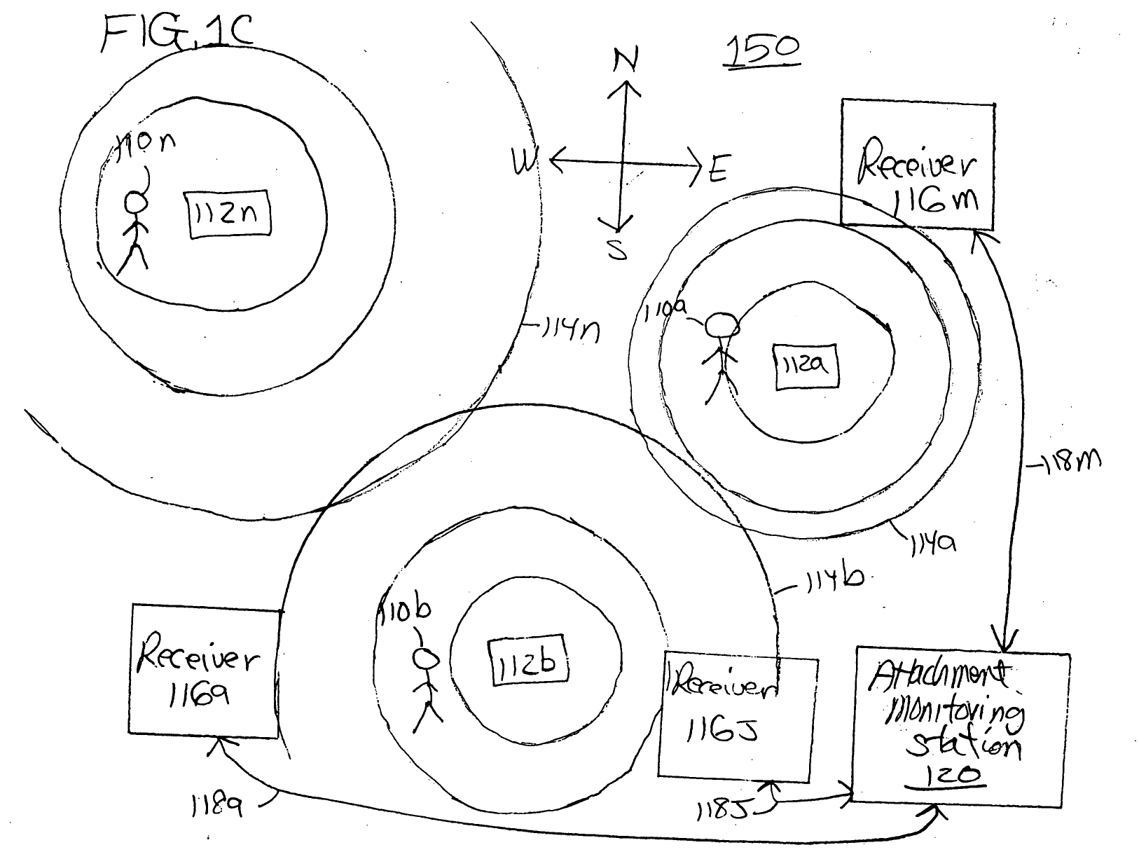

FIGS. 1A and 1B illustrate an embodiment of the invention in which an attachment monitoring 112 device is implemented herein as an electro-cardiogram (ECG) signal monitoring device 112. It will be understood that the attachment monitoring device can be used in connection with other apparatus and that this embodiment is exemplary. In this embodiment, the ECG signal monitoring device 112 includes an ECG monitoring control unit 20 that is configured to be electrically connected to a lead-wire assembly 12 comprising a cable 14 having a connector port 17 which extends to a harness 15 having a plurality of ECG lead wires 10a-10c that are each electrically connected to corresponding ECG contacts 11a-11c respectively. The ECG monitoring control unit 20 includes an embedded ECG signal receiving component and an embedded reporting signal transmitting component. Two alternate control units 22 and 24 are depicted, for connection to the lead wire assembly 12, as described in greater detail below.

In the embodiment shown, the ECG contacts 11a-11c make physical contact with the surface of the skin of a target 110 and form electrodes that receive an ECG signal 108 that is generated from the circulatory system (not shown) of the target 110.

In this circumstance, the target 110 is a person 110 who could be a patient 110 located within a health care facility and/or someone who is confined to a restricted area. In other circumstances, the target 110 could be a living thing, such as, for example, a farm or ranch animal.

Preferably, the attachment monitoring device 112, also referred hereto as a personal status monitoring device, includes the control unit 20 which can include a transport or a bedside monitor, for example. The transport monitor retains a set of batteries, enabling the device to be used as a transport apparatus. The device being battery powered consumes low power, preferably ultra low power in order to maximize its battery life. Batteries are stored within the control unit 20.

As shown, the attachment monitoring device 112 includes a plurality of (3) electrical contacts 11a-11c that are configured to make physical contact with and optionally attach to the target 110. The electrical contacts 11a-11c are configured to make physical contact with the target 110 for extended periods of time without causing harm or discomfort to the target 110. The number of lead wires and corresponding contacts can be varied depending, for example, whether a 3-lead, 5-lead or other form of ECG configuration is required and this described configuration is again also meant to be exemplary.

Typically, each electrical contact 11a-11c includes conductive material that is configured to receive the ECG signal 108 from the target 110 and to relay the ECG signal 108 to the ECG signal receiving component located within the control unit 20 of the ECG signal monitoring device 112. The ECG signal receiving component of the control unit 20 processes the analog ECG signal digitally and transmits (relays) a communication that at least represents the received ECG signal 108 (FIG. 1B) to the reporting signal transmitting component of the control unit 20.

The control unit 20 is preferably a wireless and battery powered device that is portable and person-worn, meaning that it can be attached to the body of the target 110 (such as to the body of a patient) or attached to material, such as the clothing, that is attached to the body of the target 110. For example, the control unit 20 can be disposed onto a sleeve or a belt attached to the body of the target (patient) 110.

According to one version, the ECG monitoring device 112 is a Micropaq wireless patient-worn monitoring device 22 supplied by Welch Allyn Inc. of (Beaverton, Oreg.). The Micropaq patient-worn device 22 is a patient-wearable device that provides a variety of patient vital signs monitoring functionality. This functionality includes wirelessly transmitting ECG signals that are received from a patient as well as monitoring of other patient physiologic variables, such as heat rate, body temperature and pulse oximetry. As described earlier, the patient-wom device 22 embeds an ECG signal receiving component and a reporting signal transmitting component within its housing.

The reporting signal transmitting component receives the ECG signal 108 and relays another signal communication, directly or indirectly, to a remote entity such as a display or a central monitoring station, also referred to as a central station. In one embodiment, the central monitoring station is an Acuity central monitoring station manufactured by Welch Allyn, Inc. In one type of embodiment, the reporting signal transmitting component transmits, near simultaneously (in real time), a first reporting signal (not shown) to one or more remote first reporting signal receivers (See FIG. 1C).

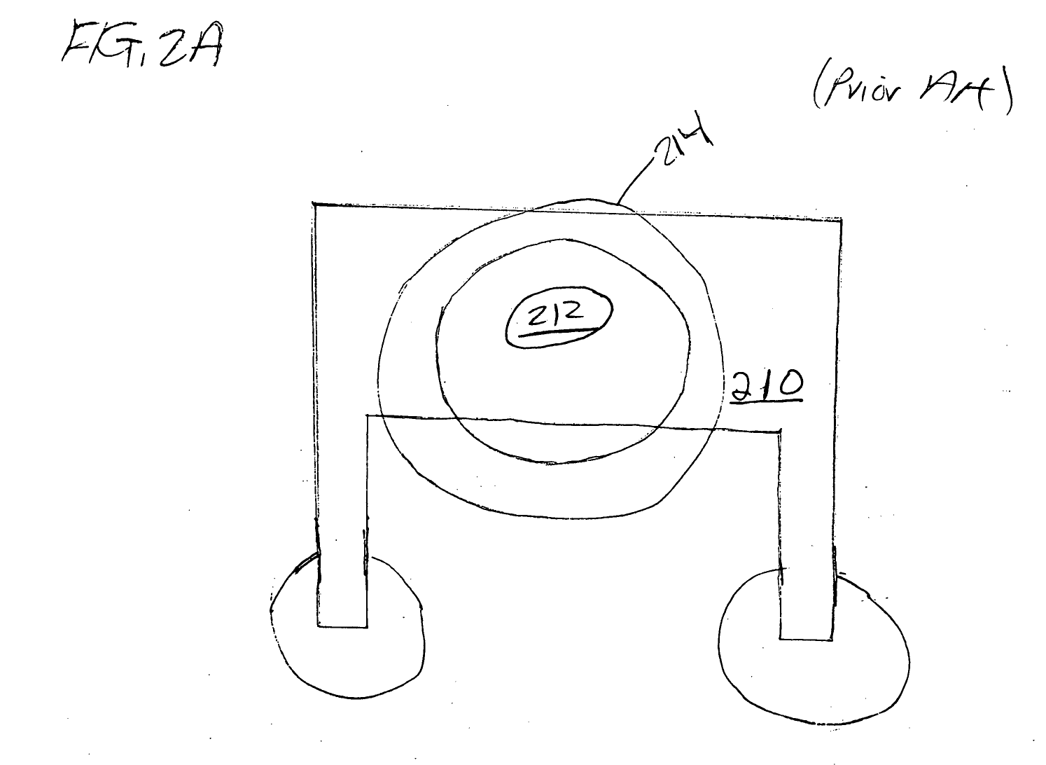

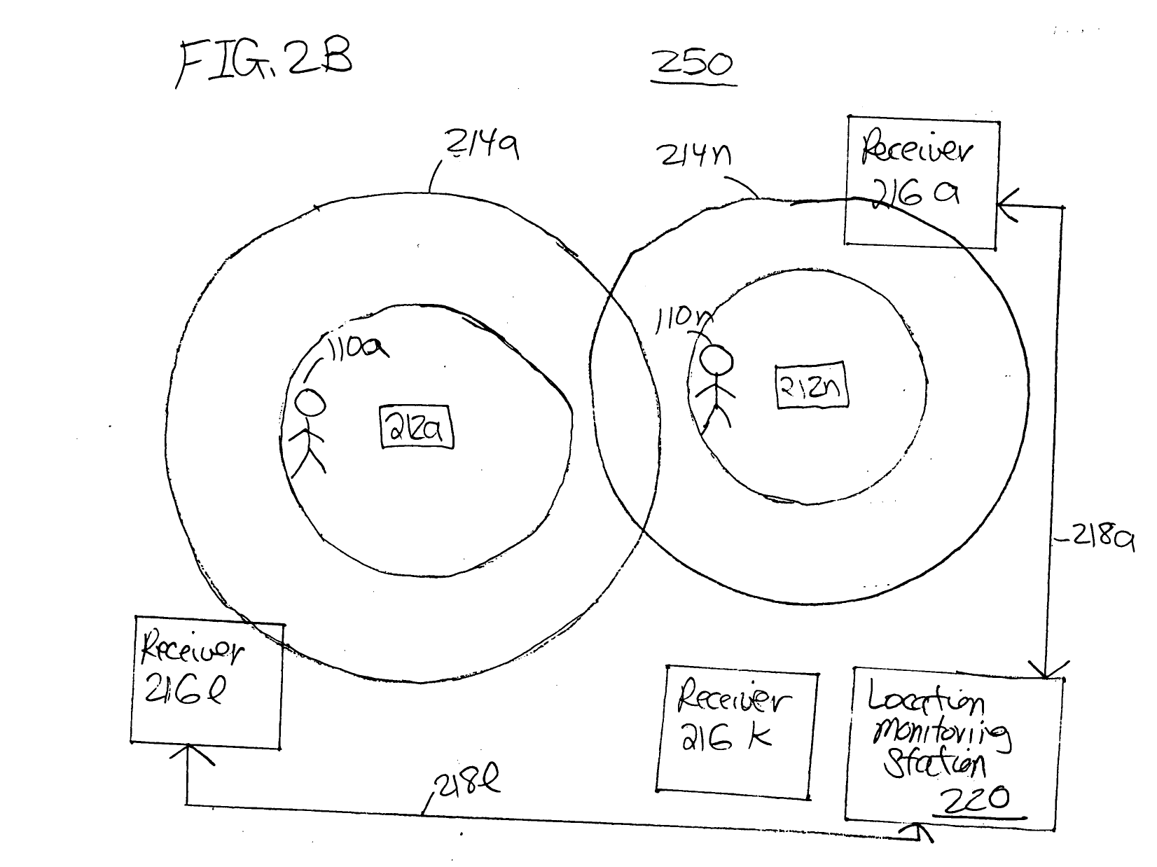

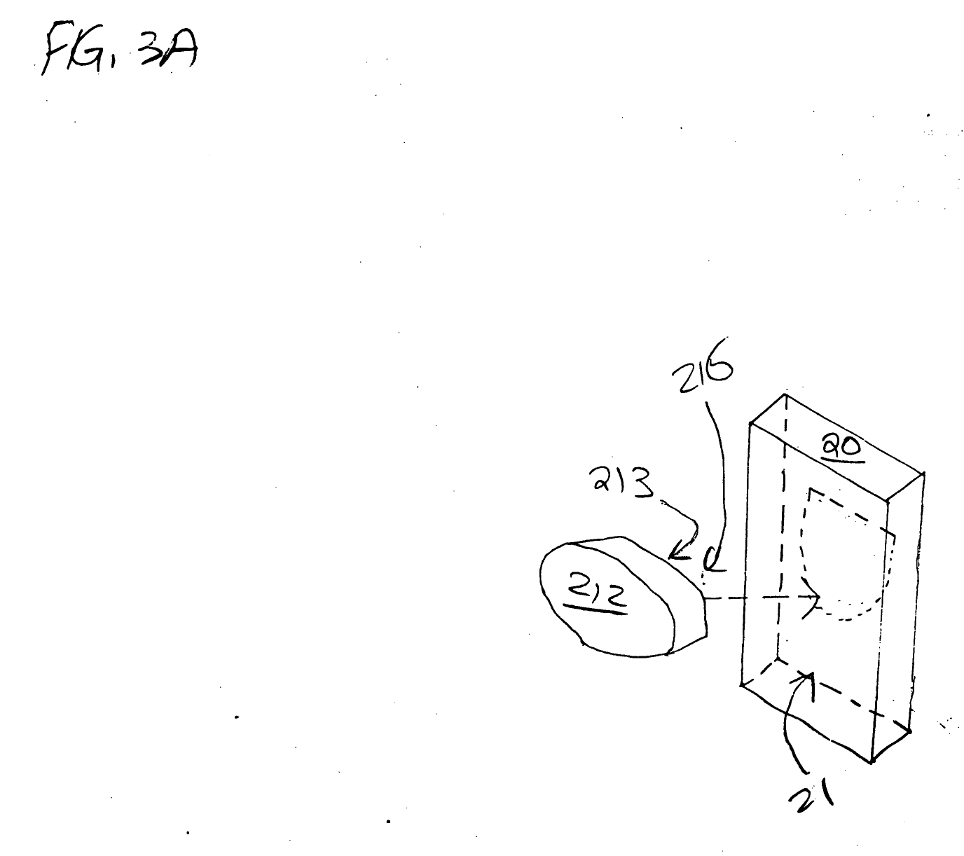

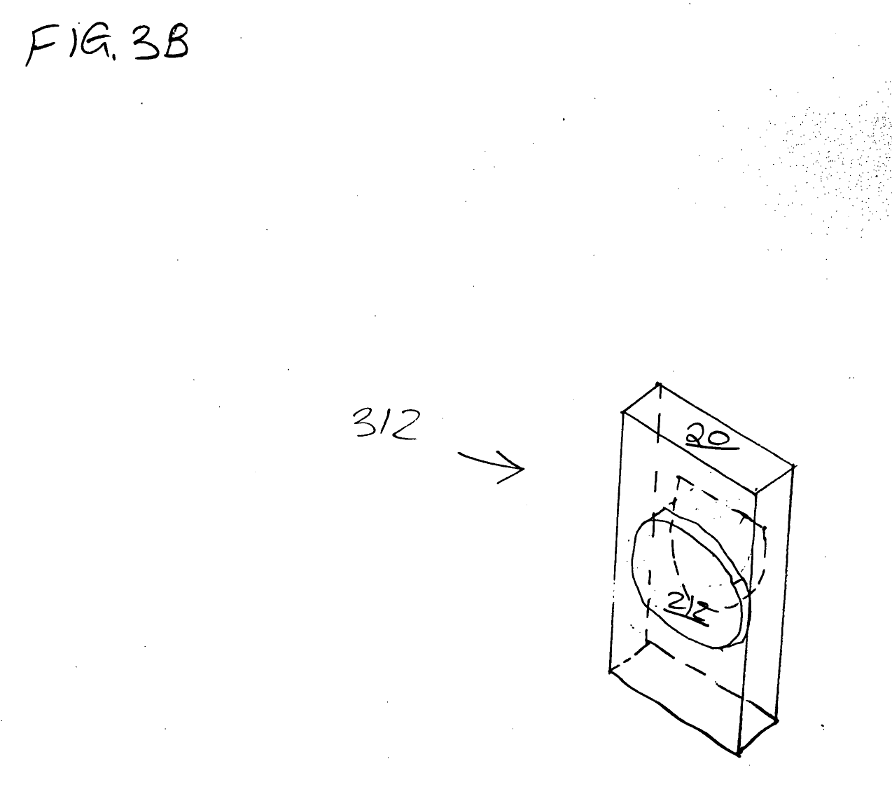

The ECG monitoning control unit 20 is configured to relay events, signals, and information preferably bi-directionally, between the control unit 20 and a remote entity, for example, a monitoring station (See FIG. 1C). Preferably, the control unit 20 transmits a wireless reporting signal (See FIG. 2) directly or indirectly to the monitoring station. Preferably, the ECG monitoring control unit 20 can use the bidirectional communication to detect the loss of communication between itself and the remote entity, and can generate a local audible alert indicating this loss of communication.

Optionally, one or more wireless receivers are employed to relay the wireless reporting signal ultimately to the monitoring station (See FIG. 2). The reporting signal communicates information representing at least the status of the reception of the ECG signal 108 by the ECG monitoring control unit while functioning as an attachment monitoring device 112.

The characteristics of the first reporting signal are not required to be equivalent to that of the ECG signal 108, and in some embodiments, may be entirely different than the characteristics of the ECG signal 108. In some embodiments, characteristics of the first reporting signal substantially resemble characteristics of the ECG signal 108.

Preferably, the first reporting signal re-communicates at least some and possibly all of the information carried by the ECG signal 108. At a particular point in time, the communication of the first reporting signal indicates the near simultaneous reception of an ECG signal by the ECG signal monitoring device 112 and indicates concurrent attachment of the ECG signal monitoring device 112 to the person 110.

Alternately and as also shown in FIG. 1A, the control unit 20 is a bedside Propaq CS wireless patient monitor 24 that is also manufactured by Welch Allyn, Inc. The depicted monitoring device is a portable device that provides a variety of patient vital signs monitoring functionality. This functionality includes wirelessly transmitting ECG signals, among other physiological parameter data that are received from a target (patient). The monitor 24 according to this embodiment, is typically attached to a portable chair or bed near the monitored target (patient), thereby functioning as a bedside monitor. As described earlier, the monitor 24 embeds an ECG signal receiving component and a reporting signal transmitting component within a housing.

In other embodiments, the ECG signal receiving component and the signal transmitting component are packaged separately and communicate via a wire line or wireless communications channel. The ECG signal receiving component can be implemented, for example, as a adhesive patch that is directly attached to the skin of the target (patient). In some embodiments, the wireless communications channel is provided by a wireless personal area network (PAN), such as for example, in accordance with the Bluetooth or ZigBee types of personal area networks.

FIG. 1C illustrates an attachment monitoring system 150 that includes at least one attachment monitoring device 112 of FIGS. 1A-1B. The system 150 includes at least one and preferably a plurality of attachment monitoring devices 112a-112n, implemented herein as ECG signal monitoring devices 112a-112n, as shown in FIGS. 1A-1B. Each ECG signal monitoring device 112a-112n is assigned to and configured to receive an ECG signal 108 from a particular associated target (patient) 110 of among a plurality of targets (patients) 110a-110n.

As shown in FIG. 1B, each ECG signal monitoring device 112a-112n is configured to each transmit a first reporting signal 114a-114n, respectively associated with each target 110a-110n, either directly or indirectly to a remote entity, such as a (attachment) monitoring station 120. In some embodiments, a plurality of attachment monitoring stations 120 are each employed at one of a plurality of assigned locations. Each attachment monitoring station 120 is configured to monitor first reporting signals received at each of the one of the plurality of assigned locations. One attachment monitoring station can be assigned to function as a primary monitoring station, also referred to as a primary central station, to perform central monitoring of signals collectively received from the plurality of attachment monitoring stations.

Optionally and as shown, a plurality of intermediate first reporting signal receivers 116a-116m receive and relay the first signals 114a-114n to the monitoring station 120. Note that the invention does not require a particular relationship between the number of ECG signal monitoring devices 112a-112n and the number of first reporting signal receivers 116a-116m, if any are employed in a particular embodiment.

According to this embodiment, each first reporting signal 114a-114n is preferably a wireless type of signal. As shown, the first reporting signal 114a-114n is received by at least one first reporting signal receiver 116a-116m. Preferably, each of the first reporting signals 114a-114n is transmitted by each device 112a-112n in a manner that is nearly simultaneous with respect to the time each respective ECG signal 108a-108n is received by each device 112a-112n from each target 110a-110n.

As shown in this embodiment, each of the first reporting signal receivers 116a-116m communicate (e.g., relay) information received from the first reporting signals 114a-114n to a monitoring station 120 via a plurality of communication channels 118a-118m. In one type of embodiment the communications channels 118a-118m are each a wire-line type of communication channel that is implemented for example, via a local area network such as an Ethernet, or wide area network (WAN). In another type of embodiment, the communications channels 118a-118m are configured as a wireless type of communication channel, such as those including an 802.11 compliant channel.

Each of the communications channels 118a-118m are not required to be of a particular type or of the same type. Preferably, the relayed information is transmitted, nearly simultaneously, with respect to the time of reception of each respective first reporting signal 114a-114n by the receivers 116a-116n.

The monitoring station 120 outputs information communicated by each of the first reporting signals 114a-114n that are associated with each target 110a-110n. Typically, the first reporting signal 114a-114n communicates at least some or all information communicated by the ECG signals 108a-108n that are received by each of the ECG signal monitoring devices 112a-112n.

Preferably, the monitoring station 120 such as, for example, an Acuity central monitoring station includes a visual display, such as a liquid crystal display (LCD) monitor, for example, to represent the information received from each ECG signal monitoring device 112a-112n. In some embodiments, the first reporting signals 114a-114n carry substantial ECG status information associated with each target 110a-110n such that the monitoring station 120 indicates an ECG status for each target 110a-110n, as well as an attachment status for each target 110a-110n.

The presence (transmission) of a first reporting signal 114a-114n at a particular time indicates the following: First, the presence of an ECG signal 108 being generated from an ECG signal generating entity 110a-110n; second, an attachment is indicated between an ECG signal monitoring device 112a-112n generating the first reporting signal 114a-114n and the ECG generating entity 110a-110n; and third, the operation of the ECG signal monitoring device 112a-112n, is indicated at that particular time.

As a result, a first reporting signal 114a-114n communicates information representing both an ECG status of an ECG signal generating entity 110a-110n as well as an attachment status between an ECG signal monitoring device 112a-112n and the ECG signal generating entity 110a-110n. Hence, the ECG signal monitoring device 112a-112n functions as an attachment monitoring device to confirm the status of an attachment between the device 112a-112n and the target 110a-110n.

The absence of a first reporting signal 114a-114n at a particular time indicates an absence of an ECG signal 114a-114n being generated from a target 100a-110n from an attached ECG signal monitoring device 112a-112n, indicates an absence of an attachment between an ECG signal monitoring device 112a-112n and a target 110a-110n, or an absence of the collect operation of the ECG signal monitoring device 112a-112n, or some combination thereof.

In some embodiments, by itself, the first reporting signal 114a-114n does not necessarily provide information uniquely identifying the ECG signal generating entity (target) 110a-110n. In addition, the first reporting signal 114a-114n by itself, does not necessarily provide information classifying the ECG signal generating entity 110. For example, the first reporting signal 114a-114n does not necessarily provide information as to whether the entity 110a-110n, for example, is a male or female, a human being, an animal or other type of living thing capable of generating an ECG or similar type of signal.

In a typical use scenario, an ECG signal generating entity (target) 110 is classified and uniquely identified. For example, in one use scenario, the target is an Alzlheimer's patient who is located within a health care facility. The target is uniquely identified, for example, by a full legal name, a health care facility identification number and/or social security number and other demographic and/or medical information. Upon physically attaching an ECG signal monitoring device 112a-112n to the target 110a-110n at a first attachment time, a first reporting signal 114a-114n is generated by the ECG signal monitoring device 112a-112n.

Preferably, the monitoring station 120 associates, for at least a period of time, the first reporting signal 114a-114n and information uniquely identifying the target 110a-110n. The period of time starts when the generation of the first reporting signal 114a-114n is initiated as a result of attaching a particular ECG signal monitoring device 112a-112n to a particular target 110a-110n, referred to herein as a first reporting signal initiation time event or a first reporting signal initiation (FSI) event, and ends when the continuity of the generation of the first reporting signal is interrupted or terminated, referred to herein as a first reporting signal termination time event or a first reporting signal termination (FST) event. An FST event occurs regardless of whether the first reporting signal is terminated definitely or indefinitely.

For definitional purposes with regard to the following description, the occurrence of an earliest first reporting signal termination (FST) event after a first reporting signal initiation (FSI) event is referred to herein as being a first reporting signal termination (FST) event. which corresponds to the first reporting signal initiation (FSI) event, or that is coupled to the first reporting signal initiation (FSI) event and vice versa. The period of time commencing at a first reporting signal initiation (FSI) event and ending at a corresponding first reporting signal tennination (FST) event, is referred to herein as a continuous first reporting signal period (CFSP).

An event in which a particular ECG signal monitoring device 112a-112n is attached to a particular target 110a-110n is herein referred to as an attachment event. An attachment event that causes a first reporting signal initiation event, is also referred to as corresponding to the first reporting signal initiation (FSI) event and as corresponding to the continuous first reporting signal period that includes the first reporting signal initiation (FSI) event, and vice versa.

Accordingly, each continuous first reporting signal period corresponds to an attachment event associated with the attachment of a particular ECG signal monitoring device 112a-112n to a particular target 110a-110n. Preferably, the particular target 110a-110n is uniquely identified and associated with a first reporting signal 112a-112n. As previously noted, the target can be, for example, an Alzheimer's patient within a health care facility and/or some one who is incarcerated within a facility.

During a continuous first reporting signal period, the presence (transmission) of a first reporting signal 114a-114n indicates the presence of an ECG signal 108a-108n being generated from the selected target 110a-110n, indicates the presence of the attachment (first attachment) between an ECG signal monitoring device 112a-112n and the target 110a-110n, and indicates the presence of the operation of the ECG signal monitoring device 112a-112n.

Implicitly, the presence of the first reporting signal 114a-114n during a continuous first reporting signal period indicates the continuous presence of the ECG signal 114a-114n, the continuous presence of the attachment (first attachment) and the continuous presence of the operation of the device 112a-112n, since the time of the FSI event corresponding to that continuous first reporting signal period.

Accordingly, the identity of a target 110a-110n corresponding to a first reporting signal within a continuous first reporting signal period can be reliably associated with the presence of the first reporting signal during the continuous first reporting signal period. The presence of a first reporting signal outside of a continuous first reporting signal period cannot be reliably associated with the identity of a target 110a-110n, and causes the identity of the target 110a-110n to be disassociated with the first reporting signal 114a-114n.

FIG. 2A illustrates a location monitoring device 212 that is physically attached to a mobile piece of hardware, such as a cart 210. The cart 210 is configured to be mobile via a wheeled structure and can therefore, for example, be selectively located throughout a large facility. The cart 210 can be utilized within many types of facilities that typically include a substantial amount of space, equipment and personnel. Such types of facilities can include, for example, a health care or manufacturing facility.

In some circumstances, personnel that require use of the cart 210 may not know, but may need to know the location of the cart 210 within the facility at a particular time. The location monitoring device 212 is configured to transmit a location reporting signal 214 that communicates information regarding the location of the cart 210 over a period of time. Other receiving devices receive the location signal and report the location of the device 212 to enable personnel of the facility to track the location of the cart 210 over a period of time.

A typical indoor location monitoring device 212, such as that provided by the Radianse Corp. of Lawrence, Mass., is configured to be directly attached to various types of materials including those such as metal, plastic, wood or paper, for example, but is unsuitable for directly attaching to the living tissue of a living entity. Direct attachment of a typical location monitoring device to a living entity, such as to the skin of a person 110, for example, can cause discomfort and/or possible hann to the living entity.

For example, a typical Radianse location monitoring device uses an adhesive surface that adheres to the above noted types of materials. Directly adhering an adhesive surface of a location monitoring device 212 to the skin of a person, such as that of an Alzheinier's patient, can cause discomfort and/or possible harm, especially over extended periods of time.

Further, the direct attachment of a location monitoring device 212, such as via an adhesive strip, to a living target 110, can result in the generation of invalid location monitoring information associated with the living target 10. For example, directly adhering an adhesive surface of a location monitoring device 212 to the skin of an Alzheimer's patient, may cause the Alzheimer's patient 110 to eliminate the discomfort associated with the attachment of the adhesive surface by detaching the adhesive surface and the location monitoring device 212 itself, from his or her skin.

As a result, the location monitoring device 212 is separated from the target 110 and the location of the target 110 can no longer accurately be monitored by the location monitoring device 112. Any further location monitoring information transmitted by the device 112 therefore unreliable.

In some embodiments, the location monitoring device 212 has a detachment indicating mechanism. The detachment indicating mechanism transmits an indication that the direct attachment (second attachment) of the location monitoring device 212 to a surface attached to a target 110 has been severed. Preferably, the detachment indicating mechanism is highly reliable so that it is difficult for someone to detach or detach and reattach the location monitoring device 212 without this detachment/reattachment being detected and reported.

Preferably, a detachment indicating mechanism of this type provides an indication of the severance of an attachment between the location monitoring device 212 and surface attached to a target 110, upon visual inspection. Typically, a detachment indicating mechanism employs, for example, a tamper switch that has a high likelihood of activating upon severance of an attachment between the location monitoring device 212 and a surface for attachment of the location monitoring device 212. In some embodiments, a strong adhesive or epoxy is used between a location monitoring device 212 and surface that is attached to a target.

In certain embodiments, a detachment indicating mechanism for the device 212 is not available or may not applicable. For example, in some embodiments, both the attachment monitoring device 112 and the location monitoring devices are integrated (permanently attached) into a single stricture such that a detachment indicating mechanism is not required for reliable reporting of the location of a target 110.

In other embodiments, some form of a detachment indicating mechanism may exist, but this mechanism may only reliably detect certain detachment scenarios and may be defeated by untrustworthy individuals to whom the device is attached initially. For example, some embodiments of a detachment indicating mechanism may be defeated by individuals attempting to steal portable equipment. For example, an individual may be able to defeat the detachment indicating mechanism, and to detach the location monitoring device 212 from a surface of the portable equipment, without triggering the detachment indicating mechanism. 1000641 In another scenario, and related to certain individuals to whom such a device may be attached the location monitoring device 212 may be indirectly attached to an article of clothing of a living target 110a-110n. For example, the location monitoring device 212 can be directly attached to a badge that is clipped to the clothing of the Alzheimer's patient 110. Alternatively, the location monitoring device 212 might be clipped or otherwise attached directly to the clothing. An Alzheimer's patient may inadvertently or unwittedly remove the attached device 212, the attached badge or the clothing and the attached device 212 or badge without knowing that such an action interferes with the validity of the location monitoring device 212 attached to the badge, or be unaware of being location monitored altogether.

Because the location monitoring device 212 remains directly attached to a badge, a detachment indicating mechanism, if any, does not activate. However, unknown to personnel receiving location monitoring information from the location monitoring device 212, any further location monitoring information transmitted by the device 212 cannot be relied upon.

In another scenario, the location monitoring device may be attached to hand cuffs or leg irons placed upon an incarcerated individual. In order to escape a facility, the hand cuffs and/or leg irons may be sawed through or otherwise removed, in such a manner to detach the hand cuffs and/or leg irons from the incarcerated individual without activating a detachment indicating mechanism, if any, and without deactivating the location reporting functionality of the location reporting device 212. Unknown to personnel receiving location monitoring information from the location monitoring device 212, any further location monitoring information transmitted by the device is therefore unreliable.

In these types of scenarios, personnel relying upon information provided by the location monitoring signal 114a-114n may be unaware that the location monitoring device 212 is no longer attached to the target 110 and that location monitoring information transmitted by the device 112 is unreliable. To address this problem, the invention provides a reliable indicator of an actual attachment (e.g., second attachment) between a location monitoring device 212 and a target 110.

To that end, FIG. 2B illustrates a device location monitoring system 250 including at least one location monitoring device 212a-212n of FIG. 1A. Each location monitoring device 212a-212n is configured to transmit a location reporting signal 214a-214n, also referred to herein as a second reporting signal 214a-214n. In this embodiment, each second (location) reporting signal 214a-214n is a wireless type of signal that is received by at least one receiver 216a-216l. Each of the receivers 216a-216l communicate information received from the second (location) reporting signals 214a-214n to the location monitoring station 220 via communication channels 218a-218l respectively.

In some embodiments, the communications channels 218a-218l are wire line communication channels that travel through a local and/or a wide area network. In other embodiments, the communications channels 218a-218l are wireless communications channels, such as compliant with the 802.11 standard.

The monitoring station 220 outputs information communicated by the second (location) reporting signals 214a-214n transmitted by each of the location monitoring devices 212a-212n. Preferably, the location monitoring station 220 includes a visual display, such as a liquid crystal display (LCD) monitor, for example, to represent the information received from each of the location monitoring devices 212a-212n via each of the second reporting signals 214a-214n, respectively.

In some circumstances, a location device 212 can be detached from one target device, such as the cart 210, and attached to another target device that is not intended to be monitored by facility personnel. For example, the location device 212 could be detached from the cart 210 and re-attached to a wheel chair, a stationary chair or a bed flame, or simply dropped onto the floor or otherwise disposed of by an individual or through loss of adhesion.

In some embodiments, a location monitoring device 212 may be configured to be tamper resistant in order to detect detachment from a target device 212. In some embodiments, the location monitoring device 212 has a detachment reporting mechanism. In one type of embodiment, the detachment reporting mechanism transmits a communication, such as an electro-magnetic signal, indicating that the physical attachment (second attachment) between the location monitoring device 212 and a target 210 has been severed. In other embodiments, physical inspection of the location monitoring device 212 reveals that the device was previously detached from a target 212, even if it is later re-attached to the target 212. However, no communication reporting mechanism exists.

As stated earlier, in some embodiments, some form of a detachment indicating mechanism may exist, but it may only reliably detect the occurrence of certain detachment scenarios and may be defeated by the actions of the target 110a-110n. For example, a solvent may be used to counteract the adhesive properties of the adhesive, and detach the location monitoring device without triggering the detachment indicating mechanism.

In this latter circumstance, further information communicated from the location device 212 to the monitoring station 120 is unreliable. If no detachment indicating mechanism exists, or if a detachment indicating mechanism does not activate or is defeated, unknown to personnel receiving location monitoring information from the location monitoring device 212, any further location monitoring information transmitted by the device 212 is unreliable.

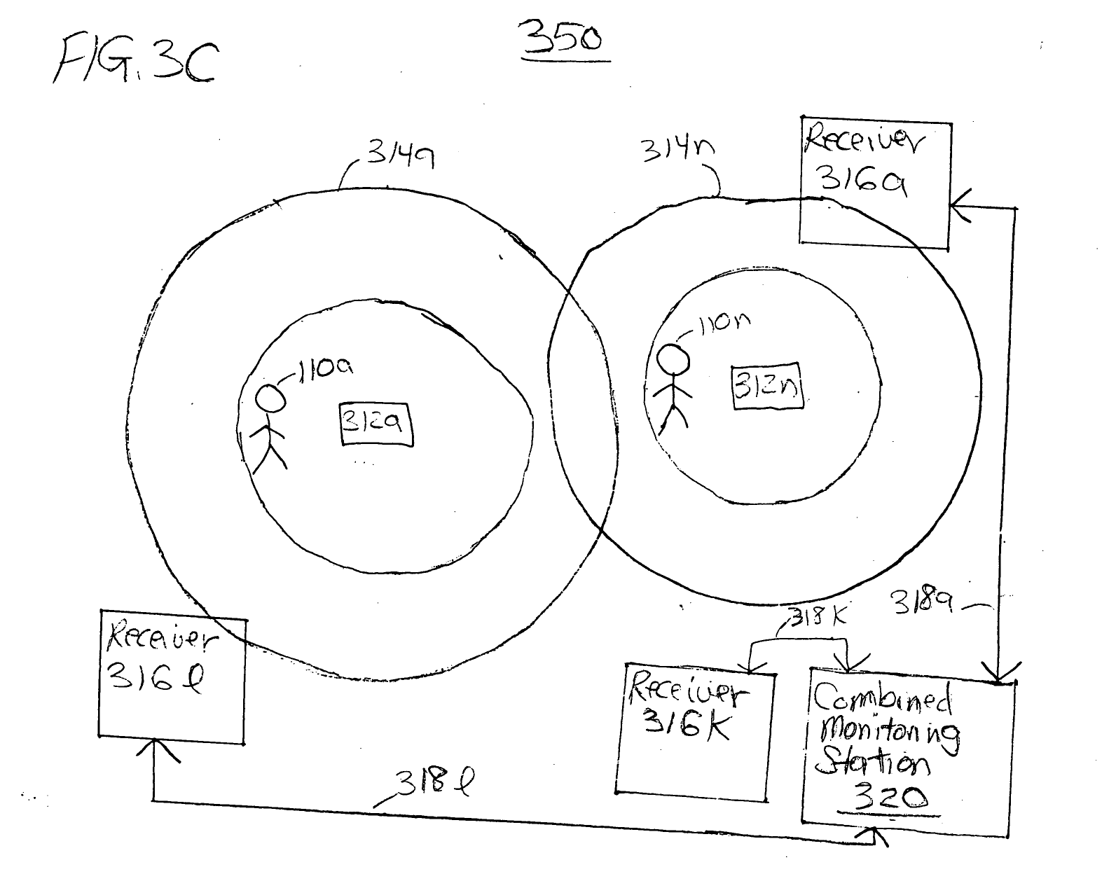

FIGS. 3A and 3B illustrates an embodiment of an enhanced location monitoring apparatus 312 that is formed from attaching a location monitoring device 212 to an attachment monitoring device 112. As previously described, the attachment monitoring device 112 is implemented in this particular embodiment as an ECG signal monitoring device 112 that is attached to a target 110.

According to this embodiment, the location monitoring device 212 is configurable to be attachable to a surface of another object. The rear surface 215 of the device 212 includes an adhesive surface. To attach the location monitoring device 212 to the first signal reporting component 20 (control unit), the rear side 215 of the device 212 is pressed and adhered to the rear surface 21 of the first reporting signal device (control unit) 20.

Further, the location monitoring device 212 includes a detachment reporting mechanism 213 located on a rear surface 215 of the device 212. The detachment reporting mechanism 213 is configured to cause the transmission of a communication to a second reporting signal receiver 216a-216n when an attachment between the location monitoring device 212 and any other object that (such as the first reporting signal device (control unit) 20) that the device 212 is attached to, is severed. The event of severing attachment (second attachment) is referred to as a detachment event.

In one embodiment, the attachment monitoring device 12 is a patient-worn patient monitoring device 22 such as a Micropaq monitoring device manufactured by Welch Allyn, Inc. and the first signal receivers 114a-114m and associated communications channels 118a-118m are implemented by a 802.11 wireless spread spectrum network such as the FlexNet wireless network utilized by Welch Allyn, Inc. Alternate implementations maybe in accordance with 802.11 a, b or g. Also, within the preferred embodiment, the location monitoring device 212 is implemented as a Radianse active RFID tag and the receivers 216a-216l are implemented as Radianse active RFID tag receivers. Both the active RFID tag and the active RFID tag receivers 216a-216l are supplied by Radianse Inc. of Lawrence, Mass.

This particular type of location monitoring device 212 employs a combination of both RF and infrared technology to accurately determine the indoor location of the location monitoring device 212 within a large indoor facility. This device 212 also includes a detachment reporting mechanism. The detachment reporting mechanism transmits a communication to a second reporting signal receiver 216a-216l if an attachment from an object, such as an attachment (second attachment) to the attachment monitoring device 112, is severed.

In this embodiment, a first reporting signal 114 provides both the ECG status of the target 110 and the attachment status (first attachment) of the attachment monitoring device 112 to the target 110. In the absence of a transmission of a detachment event communication from the location monitoring device 212, the presence of a first reporting signal 114 also indicates the attachment (second attachment) of a location monitoring device 212 to the attachment monitoring device 112. The presence of a second reporting signal 214 provides the location status of the location monitoring device 212, the location status of the target 110 and the location status of the attachment monitoring device 112 as it is physically attached to the target 110.

Physically attaching both types of devices 112, 212 together forms a combined and enhanced location monitoring apparatus 312 that communicates more reliable target location status information to the personnel of a facility. Further, different types of ECG and or other physiological monitoring devices and/or different types of location and/or other types of monitoring devices can be mixed and matched into attached device combinations that can be reliably attached to a target 110 via the attachment monitoring portion of the device combination.

In some embodiments, a (location) monitoring station 220 is configured to provide a user interface via the visual display that enables personnel to define a set of boundaries that identify a perimeter of a confining area. The targets 110a-110n are desired and/or expected and/or required to be located within the confining area. The location monitoring station 220 is also configured to detect a boundary violation event where one or more targets 110a-110n are detected to be located on a side of a boundary within tile set of boundaries that is located outside of the confining area.

Further, the location monitoring station 220 is also configured to notify personnel of one or more boundary violation events. In one type of embodiment, the location monitoring station 220 causes the generation of an audible notification and/or a visual notification and/or a signal notification upon the occurrence of boundary violation event and/or upon the occurrence of a detachment of an attachment monitoring device 112 from a target 110a-110n (signal generating entity) and/or upon the occurrence of a detachment of said location reporting device 212 from said attachment monitoring device 112.

The audible notification can be implemented as a continuous or intermittent sound, such as a beeping or chirping sound. The visual notification can be implemented as a continuous or flashing light. The signal notification can be implemented as a communication to one or more communications devices wom or carried by, or located proximate to, personnel of a facility associated with the location monitoring station. In some embodiments, the communications devices are one or more pagers and/or cellular telephones that are each worn by personnel of the facility.

In some circumstances, a target 110a-110n may travel out of range of the receivers 116a-116n. This type of circumstance is referred to as a dropout event. The monitoring station 120 is configured to detect and report a dropout event to personnel via audio and/or visual and/or signal alamis as described in response to a detachment event. The current or last reported location of the target 110a-110n can be used by facility personnel to locate and verify the status of the target 110a-110n associated with the dropout event.

If a detachment event occurs during a dropout event, the attachment monitoring device 112 is configured to alarm with an audio notification and a signal notification. The signal notification signal continues so that the central monitoring station 120 can receive it when the target travels within range of the one or more receivers 116a-116m. For example, a target 110a-110n can travel out of range when entering an elevator and can travel within range when exiting the elevator. If a detachment event does not occur before, during and after the target enters and exits the elevator, the target 110a-110n will re-establish an association with a monitoring station 120, 220 and continue to be monitored after leaving the elevator, as if the target 110a-110n did not previously travel out of range. This is an example of what is herein referred to as Rendezvous functionality as is described in greater detail according to U.S. Pat. No. 6,616,606, previously incorporated by reference herein. The Rendezvous functionality is typically incorporated into systems that also incorporate the Micropaq and Propaq CS monitoring devices.

FIG. 3C illustrates a combined monitoring system 350 including at least one combined attachment and location monitoring device 312a-312n of FIG. 3B. In one embodiment, each combined attachment and location monitoring device 312a-312n is configured to transmit a combined signal 314a-314n. The combined signal 314a-314n represents information communicated by the first reporting signal 114a-114n and second reporting signal 214a-214n.

In some embodiments, the combined signal is a plurality (grouping) of signals, that includes a separate first (attachment) reporting signal 114a-114n and a second (location) reporting signal 214a-214n. In other embodiments, the combined signal 314a-314n is one signal that combines information communicated by both the first (attachment) reporting signal 114a-114n and the second (location) reporting signal 214a-214n. As shown in this embodiment, each combined reporting signal 314a-314n is a wireless type of signal that is received by at least one receiver 316a-316l.

Each of the receivers 316a-316l communicate information received from the combined reporting signal 314a-314n to the combined monitoring station 320 via communication channels 318a-318l respectively. In some embodiments, the communications channels 318a-318l are wire line communication channels that travel through a local and/or a wide area network. In other embodiments, the communications channels 318a-318l are wireless communications channels, such as compliant with the 802.11 standard.

The combined monitoring station 320 inputs, processes and outputs information communicated by the combined reporting signal 314a-314n. The combined monitoring station 320 combines and integrates the functionality of the attachment monitoring station 120 and the location monitoring station 220 to monitor and associate both the attachment and location status of one or more targets 110a-110n.

The combined monitoring station 320 monitors, associates and indicates a first reporting signal initiation (FSI) event and first reporting signal termination (FST) event to define a continuous first reporting signal (CFSP) period over time in association with each target 110a-110n. The monitoring station 320 further associates the CFSP period and the FSI and FST events and with the location status of each target 110a-110n to provide a reliable and integrated attachment and location status of targets 110a-110n to facility personnel.

In other embodiments, non-location status reporting functionality, such as other physiological status or other types of target status for example, can combine with or replace the location status functionality. In other embodiments, other attachment monitoring functionality, such as functionality monitoring EEG signals, and combine with location status and/or non-location status functionality.

Like the monitoring stations 120 and 220, the combined monitoring station 320 includes a visual display, such as a liquid crystal display (LCD) monitor, for example, to represent the information received from each of the combined location monitoring devices 312a-312n via each of the combined reporting signals 314a-314n, respectively.

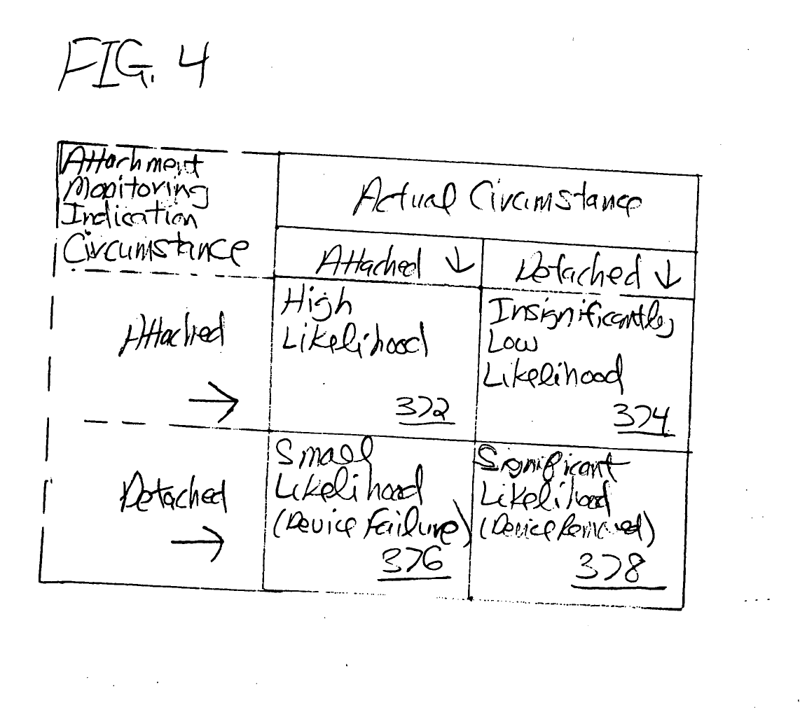

FIG. 4 is a table illustrating a qualitative estimate of the relative reliability of status information provided by the enhanced location monitoring apparatus 312 of FIG. 3B. Table entry 372 represents a “true positive” operating circumstance. A true positive operating circumstance as defined herein is the circumstance in which the apparatus 312 communicates a positive indication of the presence of an attachment (first attachment) between the apparatus 312 and a target 110 wherein this indication is valid, as opposed to being invalid. As indicated by table entry 372, given the circumstance where the apparatus 312 indicates anl attachment (first attachment) between the apparatus 312 and a target 110 (indicated circumstance), there is a high likelihood that the attachment (first attachment) actually (really) exists at that time (actual circumstance).

A “high likelihood” is assigned to this circumstance because, at this time, no suitably practical technique has been identified to detach the attachment monitoring device 112, 312 from a target 110 without interrupting (terminating) the first reporting signal 114a-114n for a small period of time. Preferably, the monitoring station 120 detects an absence of the first reporting signal 114a-114n for a time period as small as 1/60 of a second.

In this type of embodiment, even if the contacts 11a-11b were transferred and then re-attached to an ECG signal generating body of another target momentarily by the fastest means known to provide such detachment/reattachment, the resulting first reporting signal 114a-114n would be interrupted for a period of time exceeding 1/60 of a second. As a result the system 150, via the monitoring station 120, would detect the detachment of the contacts 11a-11b, despite any “fast” transfer and re-attachment of the contacts 11a-11b to another ECG signal generating entity, and indicate to personnel that the attachment monitoring device 112, 312 has been detached from the target 110. Accordingly, the apparatus 312 provides a positive indication of an attachment (first attachment) between the apparatus 312 and another entity, with high reliability.

Table entry 374 represents a “false positive” operating circumstance. A false positive operating circumstance for purposes of this description is the circumstance in which the apparatus 312 communicates a positive indication of the presence of an attachment (first attachment) between the apparatus 312 and a target 110, and in which this indication is in reality false. As indicated by table entry 374, given the circumstance in which the apparatus 312 indicates anl attachment (first attachment) between the apparatus 312 and a target 110 (indicated circumstance), there is an insignificantly small likelihood that no attachment (first attachment) actually exists (actual circumstance). As in the preceding, the apparatus 312 provides a positive indication of an attachment (first attachment) with high reliability.

It is a challenge to construct a plausible scenario in which a false positive operating circumstance can occur. One scenario is that the monitoring station 120, due to a defect, fails to detect a discontinuity of the transmission of a first reporting signal 114 that is a result of a detachment of the apparatus 112, 312 from the known target 110 and a re-attachment of the apparatus 112, 312 to another unknown target. The apparatus 112, 312 generates what appears to be, from the perspective of the monitoring station 120, a continuous and uninterrupted first reporting signal 114, despite the apparatus having been detached from the known target 110. In this circumstance, personnel are unaware of the detachment of the apparatus from the known target 110 and are misinformed regarding the location of the known target 110.

Table entry 378 represents a “tnie negative” operating circumstance. A true negative operating circumstance according to this description is the circumstance in which the apparatus 112, 312 communicates a negative indication of the presence of an attachment (first attachment) between the apparatus 312 and a target 110, and in which this indication is valid, meaning no attachment (first attachment) actually exists. As indicated by table entry 376, given the circumstance in which the apparatus 312 indicates no attachment (first attachment) between the apparatus 312 and a target 110 (indicated circumstance), there is a likelihood that there actually is no attachment (first attachment).

Table entry 376 represents a “false negative” operating circumstance. A false negative operating circumstance according to this description is the circumstance in which the apparatus 112, 312 communicates a negative indication of the presence of an attachment (first attachment) between the apparatus 312 and a target 110, and in which this indication is invalid, meaning an attachment (first attachment) does actually exist. As indicated by table entry 376, given the circumstance in which the apparatus 312 indicates no attachment (first attachment) between the apparatus 312 and a target 110 (indicated circumstance), there is a small likelihood that there actually is an attachment (first attachment).

A false negative operating circumstance can occur as a result of a device failure, in which the apparatus 112,312 fails to generate a first reporting signal even though the device is actually attached to ECG signal generating entity. This circumstance could be caused, for example, by battery exhaustion, a manufacturing defect or damage caused to the apparatus 112, 312, accidentally or intentionally by the target 110.

A benefit of the invention is that when the apparatus 112, 312 indicates the presence of an attachment (first attachment) between the apparatus 112, 312 and a target 110. there is a high likelihood that an attachment (first attachment) actually exists between the apparatus 312 and the target. As a result, the apparatus of the invention 112, 312 is particularly suitable and useful for situations in which personnel need to know with high reliability that a particular device is attached to, or located within proximity of, a particular target.

Use of other types of physical attachments to a target 110 may be less reliable, especially if the target 110 is motivated to sever the attachment and/or if there is not a continuous communication to personnel in a timely fashion of the status of the attachment to the target 110.

A discontinuity within the transmission of the first reporting signal 114, referred to as a termination or a termination event of a first reporting signal 114, indicates a significant likelihood of a detachment (severance of a first attachment) between the attachment monitoring device 112, 312 and its associated target 110, and indicates detachment (disassociation) between the location monitoring device 212 and the target 110. Also, the transmission of a detachment event communication from the location monitoring device 212 indicates a detachment (severance of the second attachment) between the location monitoring device 212 and the attachment monitoring device 112 and a detachment (disassociation) between the location monitoring device 212 and its target 110.

In the above described circumstances, in which the first and/or the second attachments are severed, personnel relying upon information provided by the location monitoring device 212 will be aware that the location monitoring device 212 is no longer attached to the target 110 and that location monitoring information transmitted by the device 212 cannot be relied upon as being associated with the target.

In other circumstances, the ECG signal monitoring device component 112 of the apparatus 312 may have ceased operating or the target (patient) has ceased generating an ECG signal 108. In either circumstance, the location status information continuing to be provided by the second reporting signal 214a-214n can quickly lead personnel to the target 110 in order to evaluate the type of circumstance causing the termination of the first reporting signal 114 and to take appropriate action.

Another benefit of the invention is that in the unlikely event that the attachment monitoring device 112 transmits a false negative indication, the cost of such an event (occurrence) is small. For example, upon the occurrence of such an event, one of the personnel (attendant) of the facility can walk to the currently reported or last reported location of the target 110 to verify the status of the target 110 and to correct any apparent problem with the device 112. The event may be caused by a low battery or loose cable which can be corrected by an attendant. Upon fixing an apparent problem, the status of the target can be reset at the monitoring station and/or the attachment monitoring device 112 can be replaced with a more reliable copy of the device 112.

In accordance with the invention, the location monitoring device 312 provides location information for persons and living things with particular reliability. Any detachment of the attachment device 112, 312 from the body of a living target 110 is reliably indicated by the termination of a first reporting signal 114a-114n.

In another type of embodiment, the attachment monitoring device 112 and the location monitoring device 212 can be integrated into one combined attachment/location monitoring device that transmits both a first 114a-114n and a second 214a-214n signal. In a variation of this type of embodiment, the combined attachment/location monitoring device transmits a combined signal that communicates information indicating both the attachment status and location status of the attachment/location monitoring device. The attachment status and the location status can each be represented by separate characteristics of the combined signal.

For this type of embodiment, when a signal characteristic representing the attachment status indicates the occurrence of a detachment event, the location characteristic of the signal, at the time of the detachment event, indicates where the detachment of the combined monitoring device from the target 110, had occurred so that personnel can take appropriate action.

In other embodiments, the attachment monitoring device 112 can be attached to other types of location monitoring devices. In one type of embodiment, the attachment monitoring device 112 is attached to an outdoor location monitoring device such that the location and/or physiological (e.g., ECG) status of a target 110 can be monitored while the target 110 is located outdoors for example, while driving on a highway, while in a large crowd at a sporting event, or on a golf course, or in a park etc.

In one type of outdoor location monitoring embodiment, the outdoor location monitoring device 112 employs global positioning system (GPS) technology. GPS technology employs a plurality of GPS satellites that receive a radio frequency signal transmitted from a GPS location monitoring device 212. The GPS satellites are configured to accurately identify the location of a target transmitting an RF signal. The employment of GPS technology within a location monitoring device 212 enables the location of an attached target 110 to be tracked over a wide areas on the surface of the earth, provided that a direct path of signal transmission between the target 110 and any participating GPS satellite is not obstructed as a result of the target being located inside of a structure, below an outdoor roof or otherwise impeded.

In one type of outdoor location monitoring embodiment, location monitoring device employs “enhanced 911 ” location technology. This technology is currently under development and is required to locate mobile telephones during a possible emergency, such as in response to the dialing of ‘911’ from a mobile telephone. Currently, “enhanced 911” technology is expected to be derived from GPS and/or mobile telephone signal triangulation related technologies. Other technologies may be employed.

In other types outdoor location monitoring embodiments, the location monitoring device 212 employs other types of radio frequency (RF) technology. In some RF technology embodiments, 802.11 wireless access points and networking are employed to support the operation of a location monitoring device 212 outdoors. These types of location monitoring solutions include those, for example, supplied by business entities such as Aruba Networks of Sunnyvale, Calif., Airespace of San Jose, Calif. and Ekahau of Saratoga, Calif.

Radio frequency technology can be employed, by itself, to support indoor location monitoring. However, the accuracy of RF technology by itself, is typically less than the combination of RF technology and other technologies. For example, particular embodiments of RF technology in combination with infrared signal technology has yielded more accurate indoor location monitoring systems than RF technology alone, as claimed in association with indoor location monitoring products provided by Radianse Inc.

With respect to outdoor location embodiments, RF technology over a large area will typically not yield results as accurate as GPS technology. In other outdoor embodiments, the outdoor location monitoring device 112 can employ infrared or ultrasonic technology. However, the range of this technology is generally much shorter than that of GPS or other types of radio frequency technology.

In other types of embodiments, the attachment monitoring device 112 can be attached to one or more devices that are other than or not necessarily location monitoring devices 212. For example, if an Alzheimer's patient 110 must wear an oxygen mask or an insulin injection device, the attachment monitoring device 112 can be configured to indicate that the air mask and/or insulin injection device are in fact, being worn by the Alzheimer's patient 110. Also, in other embodiments, the attachment monitoring device 112 can be attached to devices monitoring other physiological characteristics of a target 110, including devices monitoring brain waves (EEG), body temperature or pulse rate, for example.

As previously noted, the physiological signals can be generated and monitored by the target (patient) vis a vis the attachment monitoring device 112, including brain wave activity, for example. In yet other types of embodiments, the attachment monitoring device 112 can be configured to attach to other living things that also generate an ECG signal, including domestic, family and zoo animals, including birds.

While the present invention has been explained with reference to the structure disclosed herein, it is not confined to the details set forth and this invention is intended to cover any modifications and changes as may come within the scope and spirit of the following claims.

What is claimed is:

1. A method for locating an entity generating a continuous signal that does not function as a location reporting signal, said method comprising the steps of:
providing a entity that generates a entity signal continuously over time;
providing a entity attachment monitoring device that when activated, is configured to attach to said entity and to communicate a first reporting signal to a remote entity, said first reporting signal representing a presence of said entity signal and a presence of a first attachment to said entity;
providing a location reporting device that when activated, is configured to communicate a second reporting signal representing its device location to said remote entity;
attaching said attachment monitoring device to said entity via said first attachment and attaching said location reporting device to said attachment monitoring device via a second attachment and activating said attachment monitoring device and said location reporting device at a first time; and
assigning an entity location to said entity, said entity location being assigned as being approximately equal to said device location during a period of time where said entity signal has been received continuously since said first time to said remote entity.

2. The method of claim 1 including the step of providing a signal continuity detector within said attachment monitoring device that is configured to detect and report if said entity signal has not been received continuously since said first time.

3. The method of claim 2 where if said signal continuity detector detects at a second time that said first entity signal has not been received continuously since said first time, then said method including a step of reporting a first attachment severance event to said remote entity and said method including a step of assigning said entity location to being equal to an unknown value at or after said second time.

4. The method of claim 2 where if a severance occurs to said second attachment, then said method including a step of reporting said severance at a third time and said method including a step of assigning an unknown value to said entity location at or after said third time.

5. The method of claim 3 including a step of assigning a detach location of said attachment monitoring device to being equal to a value of said entity location at said second time, said step of assigning preformed at or after said second time and before assigning said entity location to being equal to unknown value.

6. The method of claim 4 including a step of assigning a detach location of said attachment monitoring device to being equal to a value of said entity location at said second time, said step of assigning preformed at or after said second time and before assigning said entity location to being equal to unknown value.

7. The method of claim 1 including a step in which a first reporting signal receiver and a second reporting signal receiver relay said first and second reporting signals respectively, to a monitoring station including a user interface display that outputs at least some information communicated by said first and second reporting signals.

8. The method of claim 7 including a step of representing an entity location and a device location as one location by said user interface display during a period of time where said signal has been received continuously since said first time.

9. The method of claim 1 in which said attachment monitoring device is implemented as an ECG signal monitoring device.

10. The method of claim 9 where said ECG signal monitoring device is a target worn and wireless communicating ECG signal monitoring device.

11. The method of claim 10 where said location reporting device is an indoor location reporting device.

12. The method of claim 11 where said indoor location reporting device is configured to be attachable to a target worn and wireless communicating ECG signal monitoring device

13. The method of claim 1 where said location reporting device is an outdoor location reporting device.

14. The method of claim 13 where said location reporting device is a global positioning system (GPS) location reporting device.

15. The method of claim 1 in which said attachment monitoring device and said location reporting device are manufactured as one combined device.

16. The method of claim 15 including a step of having said combined device transmit a third reporting signal that communicates information combining at least some information communicated by said first reporting signal and said second reporting signal.

17. The method of claim 7 where said signal generating entity is a person whose location is desired to be constrained within a particular set of boundaries.

18. The method of claim 1 where said signal generating entity is a living thing and including a step in which said first reporting signal functions to communicate a physiological status of said living thing and an attachment status of said first attachment to said living thing.

19. The method of claim 1 where said location reporting device is supplemented or replaced by a reporting device other than a location reporting device.

20. The method of claim 1 where said signal generating entity is a device and said attachment monitoring device monitors a measurable characteristic of the device.

21. The method of claim 17 including the step of generating at least one of an audible notification and a visual notification if said location of said signal generating entity is outside of said set of boundaries, or if said attachment monitoring device has been detached from said signal generating entity or if said location reporting device has been detached from said attachment monitoring device.

22. The method of claim 21 including the step of generating a signal notification in addition to said audible and/or visual notification, said signal notification communicating said notification via one or more communications devices that are carried or worn by, or located proximate to, one or more personnel of a facility that are associated with said monitoring station.

23. The method of claim 22 where the communications device is at least one of a pager a mobile telephone.

24. An apparatus for reporting the location of an entity that generates a continuous signal that does not function as a location reporting signal, comprising:
an entity attachment monitoring component that when activated, is configured to attach to an entity and to communicate a first reporting signal to a remote entity, said first reporting signal represents a presence and a reception of said entity signal by said attachment monitoring component and represents a presence of an attachment to said entity by said attachment monitoring component;
a location reporting component that when activated, is configured to communicate a second reporting signal representing a device location to said remote entity;
an attachment component that constitutes an attachment between said entity attachment monitoring component and said location reporting component, said attachment component is configured such that severance of said attachment is communicated to said remote entity.

25. A system for locating an entity that generates a continuous signal, comprising:
an entity attachment monitoring device that when activated, is configured to attach to an entity that generates a continuous entity signal over time and that is configured to communicate a first reporting signal that represents an attachment to said entity and represents the presence of said entity signal to a remote entity;
a location reporting device that when activated, is configured to communicate a second reporting signal representation of its device location, to said remote entity;
and where said entity attachment monitoring device is attached to said entity and where said location reporting device is attached to said attachment monitoring device and where said attachment monitoring device and said location reporting device are activated at a first time; and
where an entity location is assigned to said entity as being approximately equal to said device location during a period of time where said first reporting signal has been received continuously since said first time and while said attachment has not been severed.
